(19) United States
(12) Patent Application Publication
(10) Pub. No.: US 2007/0125313 A1
(43) Pub. Date: Jun. 7, 2007

(54) Presence detector mat

(75) Inventor: Stephen W. Fleetwood, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/364,093

(22) Filed: Feb. 28, 2006

Related U.S. Application Data
(63) Continuation-in-part of application No. 11/294,934, filed on Dec. 6, 2005.

(51) Int. Cl. A01K 15/02; A01K 29/00

(52) U.S. Cl. 119/721; 119/28.5

(57) ABSTRACT

A presence detector mat for monitoring the presence of an animal within a defined area. The presence detector mat includes a variable parallel-plate capacitor separated by an elastic spacer, and a sensing mechanism. An electrical power source is provided to establish an electrical charge differential to the variable parallel-plate capacitor. The sensing mechanism is capable of detecting changes in the capacitance of the variable parallel-plate capacitor and transmitting a signal based upon such change in capacitance.

### CROSS-REFERENCE TO RELATED APPLICATIONS

This application is a continuation in part of prior Application No. 11/294,934, filed Dec. 6, 2005.

### STATEMENT REGARDING FEDERALLY SPONSORED RESEARCH OR DEVELOPMENT

Not Applicable

### BACKGROUND OF THE INVENTION

1. Field of Invention

This invention pertains to a device for detecting the presence of an animal. More particularly, this invention pertains to a portable device for monitoring the presence of an animal within a defined area without using tangible barriers.

2. Description of the Related Art

Pet owners are often faced with the task of monitoring the activities of their pet. Various circumstances necessitate alerting the pet owner to the fact that a pet has entered or left a designated area such as when pet owners attempt to contain their pet within such designated area, or to prohibit their pet from entering such designated area. Pet containment prevents an animal from chewing or scratching the pet owner's property or from tracking dirt and filth through the pet owner's home. Pet prohibition allows a pet owner to designate an item, such as the location of a valuable possession, and prevent the pet from approaching the item.

Pet owners not only want to monitor the presence of a pet within a small defmed area, but want to do so in a manner that is safe and pleasant for the pet and in a manner that is aesthetically pleasing. Additionally, pet owners want unhindered access to the area throughout the time that the pet's presence is being monitored. Often, pet owners must monitor the presence of their pet within a designated area that is not within the pet owner's home, but rather within another home or other public place. Circumstances such as these include the pet owner visiting family or a friend and bringing the pet along, or the pet owner leaving the pet with a friend and going out of town, or the pet owner taking the pet to a public place where the pet must be confined to a small area. Consequently, the pet owner requires a presence detector device that is portable.

Conventional devices that address the discussed issues of animal presence monitoring include electronic containment fences that bound an area with an antenna. A transmitter connected to the antenna generates a signal that broadcasts at a limited range from the antenna creating an electronic boundary. An alert unit carried by an animal is designed to receive the broadcast signal when the animal approaches the antenna. Depending on the proximity to the boundary, i.e., the signal strength of the received signal, the alert unit issues a warning or a correction stimulus that is intended to deter the animal from moving closer to the boundary. When the animal is outside the broadcast range of the signal, it is considered to be in the safe zone where no stimulus is received. While such systems are generally satisfactory for larger areas, such as a yard, the signal must have a broadcast range sufficient to reach the alert unit at the height of a large dog. Accordingly, the minimum effective broadcast distance prohibits the use of the electronic containment fences in small areas, i.e., crate-sized areas, because there is insufficient distance to create a safe zone.

### BRIEF SUMMARY OF THE INVENTION

A presence detector mat for monitoring the presence of an animal within a defined area is disclosed. The presence detector mat includes a variable parallel-plate capacitor separated by an elastic spacer, and a sensing mechanism.

According to one embodiment of the present invention, a planar base member is coupled to a platform structure. The planar base member includes a first capacitor plate carried by an insulator. The platform structure includes a second capacitor plate carried by a dielectric plate. The platform structure is elevated above the planar base member by an elastic spacing system positioned between the planar base member and the platform structure. In this configuration, the second capacitor plate is brought into substantial proximity with the first capacitor plate, with the two capacitor plates substantially overlapping.

An electrical power source is configured to provide an electrical charge differential to the first and second capacitor plates. The sensing mechanism includes a controller and a transmitter. The controller emits a signal in response to variation in the capacitance of the first and second capacitor plates. In this regard, a variation in the capacitance is induced by a change in state, such as a pet either stepping onto the platform structure or a pet stepping off of the platform structure. The transmitter is capable of transmitting a signal based upon the output of the controller. Should the conditions indicate that an animal has crossed the boundary defined by the variable parallel-plate capacitor, the transmitter produces a signal that alerts a secondary device of the animal's behavior.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of the presence detector mat constructed in accordance with several features of the present invention;

FIG. 2 is a partial cross-sectional view of a presence detector mat of FIG. 1;

FIG. 3 is a partial cross-sectional view of another embodiment of a presence detector mat constructed in accordance with several features of the present invention;

FIG. 4 is a circuit diagram of the presence detector mat of FIG. 1;

FIG. 5 is a circuit diagram of a typical secondary device used in conjunction with the presence detector mat of the present invention;

FIG. 6 is a flow diagram of the control program executed by the presence detector mat;

FIG. 7 is a flow diagram of the control program executed by the controller;

FIG. 8 is a flow diagram of the control program executed by a typical secondary device used in conjunction with the presence detector mat of the present invention.

### DETAILED DESCRIPTION OF THE INVENTION

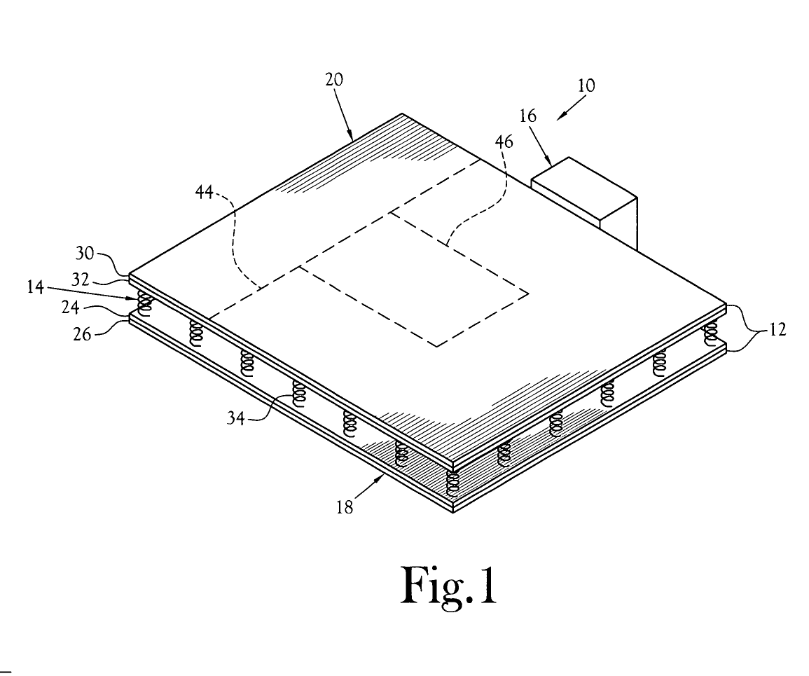

A presence detector mat for monitoring the presence of an animal within a defined area is disclosed. The presence detector mat 10, shown in perspective view as FIG. 1, includes a variable parallel-plate capacitor 12 separated by an elastic spacing system 14, and a sensing mechanism 16. The sensing mechanism 16 is capable of detecting changes in the capacitance of the variable parallel-plate capacitor 12 and transmitting a signal based upon such change in capacitance. Consequently, when the animal moves across the boundary defined by the variable parallel-plate capacitor 12, the sensing mechanism 16 transmits a signal to signify the presence or absence of the animal.

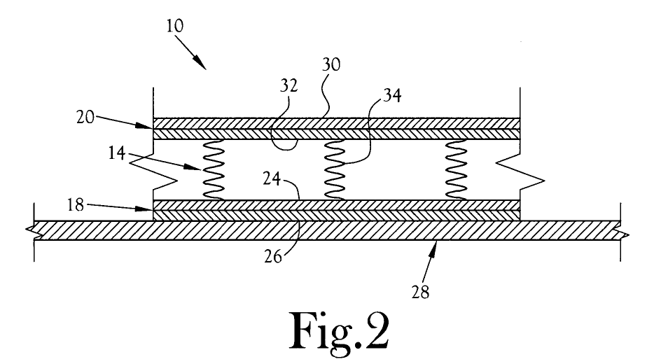

FIG. 2 illustrates a partial, cross-sectional view of one embodiment of the presence detector mat 10 constructed in accordance with the various features of the present invention. As shown in FIG. 2, the presence detector mat 10 includes a planar base member 18 coupled to a platform structure 20. The planar base member 18 includes a first capacitor plate 24 carried by an insulator 26. The insulator 26 is defined by a substantially rigid, non-conductive planar member, while the first capacitor plate 24 is defined by a substantially conductive planar member. The first capacitor plate 24 is coupled to the insulator 26 such that the insulator 26 elevates and insulates the first capacitor plate 24 from electrical conductivity with a floor 28, the ground or a similar supporting surface (not illustrated). Similarly, the platform structure 20 includes a second capacitor plate 30 carried by a dielectric plate 32. The dielectric plate 32 is defined by a substantially rigid, non-conductive planar member, and the second capacitor plate 30 is defined by a substantially conductive planar member. The second capacitor plate 30 is carried by the dielectric plate 32.

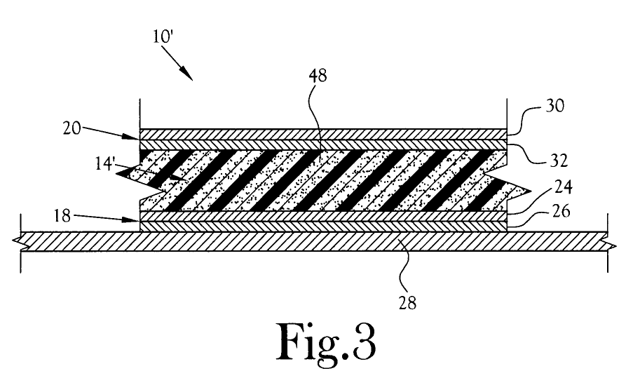

The platform structure 20 is elevated above the planar base member 18 by an elastic spacing system 14 positioned between the planar base member 18 and the platform structure 20. In this configuration, the second capacitor plate 30 is brought into substantial proximity with the first capacitor plate 24, with the two capacitor plates 24, 30 substantially overlapping. The overlapping portions of the two capacitor plates 24, 30 are thus separated by the dielectric plate 32. The elastic spacing system 14 includes a region which is resiliently deformable upon a downward force being applied to the platform structure 20. A downward force applied to the platform structure 20 therefore results in the first and second capacitor plates 24, 30 being brought into closer proximity to one another. Upon termination of the downward force, the elastic spacing system 14 returns to its original shape, thus restoring the first and second capacitor plates 24, 30 to their original configuration. In the illustrated embodiment, a plurality of springs 34 is provided to accomplish the elastic spacing system 14 of the present invention. As illustrated in FIG. 3, another embodiment of the presence detector mat 10′ includes a layer of elastomeric foam 48 to accomplish the elastic spacing system 14′. It will also be understood that other suitable devices, such as pistons or pneumatic devices, exist to accomplish the elastic spacing system 14 without departing from the spirit and scope of the present invention.

Referring to FIG. 1, in the present embodiment, the planar base member 18 substantially defines the perimeters of both the first and second capacitor plates 24, 30, as well as the dielectric plate 32. In another embodiment, a designated perimeter 46 defines the perimeters of both the first and second capacitor plates 24, 30. In this configuration, both first and second capacitor plates 24, 30 have surface areas smaller that the planar base member 18 and the dielectric plate 32. In yet another embodiment, the second capacitor plate 30 terminates at a line 44 within the perimeter of the planar base member 18. In this configuration, only a portion of the first capacitor plate 24 overlaps with the second capacitor plate 24. Based on the foregoing, those skilled in the art will recognize many possible configurations for the first and second capacitor plates 24, 30 to accomplish the present invention.

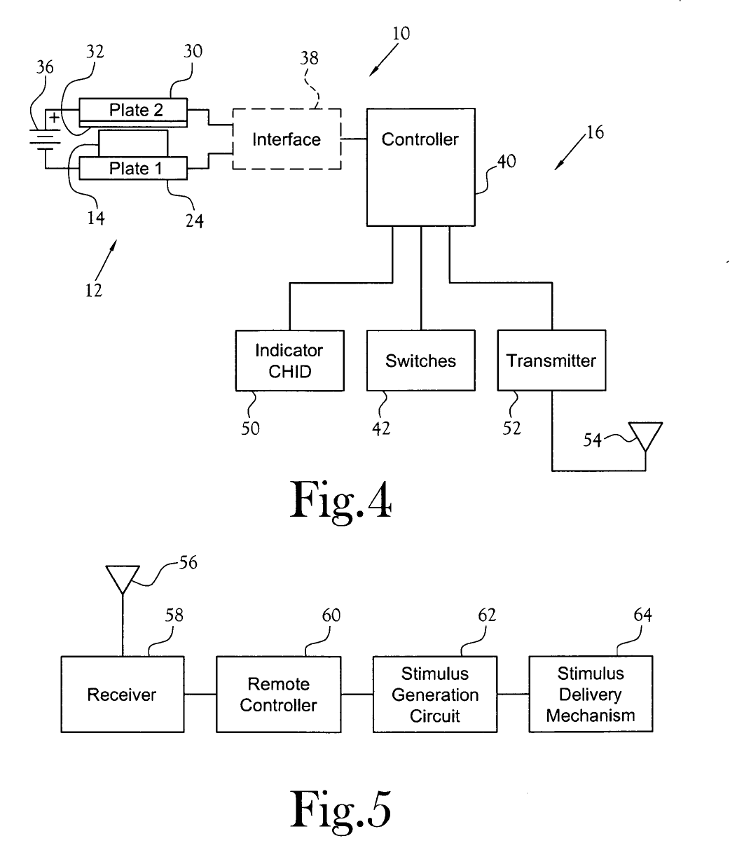

FIG. 4 is a circuit diagram of the presence detector mat 10, showing various electrical connections of one embodiment of the sensing mechanism 16. As shown in FIG. 4, an electrical power source 36 is configured to provide an electrical charge differential to the first and second capacitor plates 24, 30. In the present embodiment, the electrical power source 36 is configured to provide a negative electric charge to the first capacitor plate 24 and a corresponding positive charge to the second capacitor plate 30. In another embodiment, the electrical power source 36 is configured to provide a negative electric charge to the first capacitor plate 24 and a corresponding positive charge to the second capacitor plate 30. In either configuration, the first and second capacitor plates 24, 30 together with the electrical power source 36 serve as a variable parallel-plate capacitor. To this extent, it is appreciated that a plurality of capacitor plates 24, 30 can be incorporated into the presence detector mat 10 in numerous configurations to accomplish a variable parallel-plate capacitor 12.

As shown in FIG. 4, the first and second capacitor plates 24, 30 are separated by the dielectric plate 32 and the elastic spacing system 14. The first and second capacitor plates 24, 30 are connected through an interface 38 to a controller 40. The controller 40 serves to detect the capacitance between the first and second capacitor plates 24, 30. Based on such capacitance detection, the controller 40 determines if a threshold value has been exceeded which would be representative of an animal stepping onto the presence detector mat 10. Those skilled in the art will recognize that the controller 40 can be any device suitable for providing the necessary logic including a collection of discrete components, a processor, a programmable interrupt controller, and other similar devices. The controller 40 signals a human interface device 50 indicating for a visual, audible, or other representation that the animal is on or off the presence detector mat 10. A plurality of switches 42 control the controller 40 for turning it on and off, setting the threshold sensitivity of the capacitance detection to accommodate pets of different weights.

In the event the threshold value has been exceeded, the controller 40 supplies a signal to a transmitter 52. The transmitter 52 then transmits the signal through an antenna 54 to alert a secondary device 94, such as a correction collar worn by the pet, of the animal's behavior. FIG. 5 is a circuit diagram of one such secondary device 94. The signal transmitted by the transmitter 52 is received by a remote antenna, indicated at 56 in FIG. 5. The received signal is then fed to the receiver 58, which in turn provides a signal to a remote controller 60. The remote controller 60 then signals a stimulus generation circuit 62, which in turn activates a stimulus delivery mechanism 64. The stimulus delivery mechanism 64 then provides a corrective stimulus for the animal.

Referring to FIGS. 4 and 5, in one embodiment, the transmitter 52 broadcasts a radio frequency signal that is received by the remote antenna 56. However, those skilled in the art will recognize that other types of transmissions can be used without departing from the spirit and scope of the present invention.

The presence detector mat 10 is adapted to be responsive to the force of the body weight of an animal. One embodiment of the presence detector mat 10 operates simply as a switch and effectively produces a binary output indicating either no weight or some weight. More discriminating embodiments of the presence detector mat 10 operate on the principle of a variable scale to detect the presence of the animal allowing for triggering based on variations in weight, such as when the animal partially leaves the presence detector mat 10 and transfers a significant amount of weight off of the presence detector mat 10. The mat is in a “normal” condition when a pet is on it and issues an indication when the capacitance changes due to the pet stepping off of it. Also, the mat is capable of being set up in a “normal” state with no weight on the mat and sounds an alarm when the pet steps on the mat.

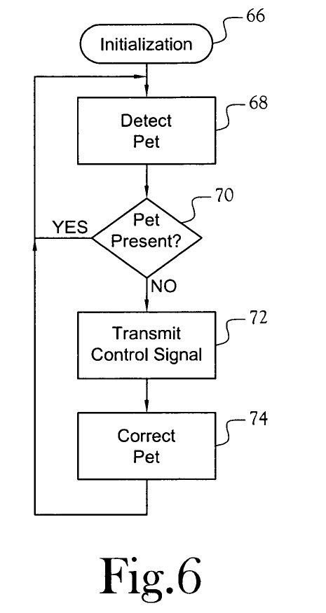

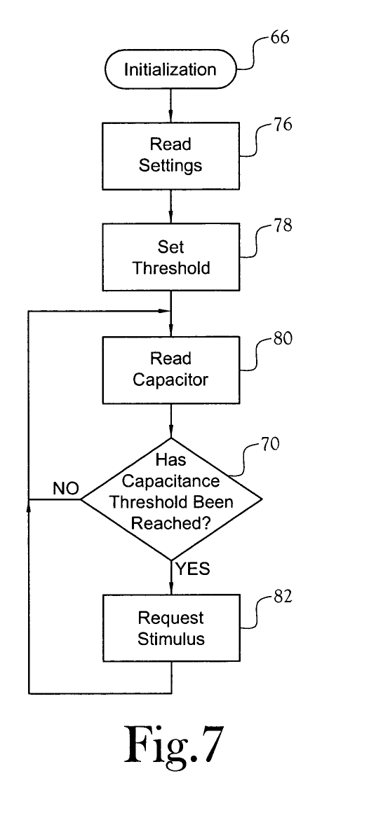

FIGS. 6 and 7 are flow diagrams of the control program executed by the controller 40. The control program is initialized 66 to prepare the system to a ready state. The controller 40 detects the initial presence or absence 68 of an animal by reading the settings 76 from the switches 42 and setting a threshold for presence detection 78. In the main loop of the routine, the controller 40 determines the continued presence or absence 70 of the animal by reading the capacitance value 80 of the parallel-plate capacitor 12. One skilled in the art will appreciate that the step of reading capacitance includes the digitization of the analog voltage of the first and second capacitor plates 24, 30. If the capacitance threshold value has been reached, the controller 40 sends a stimulus request 82 to the transmitter 52 for transmission to the secondary device 94. If the capacitance threshold has not been reached, i.e., the capacitance value remains high indicating the animal is present on the mat, the controller 40 continues to read the capacitance value 80 of the parallel-plate capacitor 12 and the loop continues.

In another embodiment, if the capacitance threshold has not been reached, the repeating portion of the method updates the threshold for presence detection 78. In this configuration, variations in animal weight are compensated for without reinitializing the presence detector mat 10. The first embodiment places emphasis on continued monitoring of the animal's behavior by, in effect, ignoring subsequent changes to the amount of animal weight perceived by the presence detector mat 10 either accidentally or on purpose. The alternate embodiment emphasizes flexibility by allowing on-the-fly changes in the animal's weight.

In the illustrated embodiment of FIGS. 6 and 7, the controller 40 sets the capacitance threshold for presence detection 78 as a capacitance value lower than the capacitance value at the initial presence or absence detection 78. In this configuration, achievement of the capacitance threshold value allows the controller 40 to monitor the continued presence of the animal by alerting the user when the animal leaves the mat 10, thereby lowering the capacitance reading. In another embodiment, the controller 40 sets the capacitance threshold for presence detection 78 as a capacitance value higher than the capacitance value at the initial presence or absence detection 78. In this configuration, achievement of the capacitance threshold value allows the controller 40 to monitor the continued absence of the animal by alerting the user when the animal enters the mat 10.

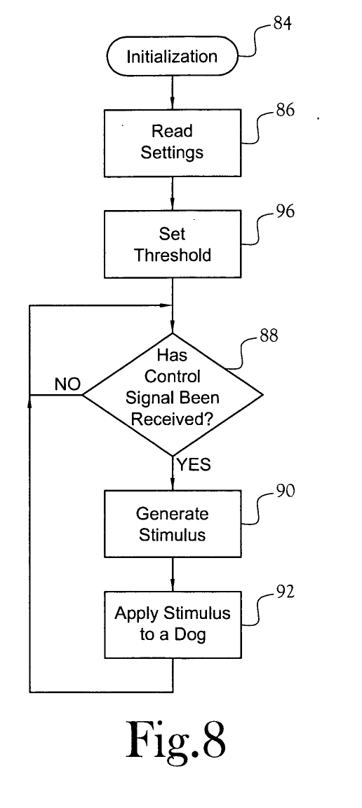

FIG. 8 is a flow diagram of the control program executed by the secondary device 94. The secondary device control program is initialized 84 and the remote controller 60 reads settings 86 from the secondary device 94 to set an initial state threshold 96. The remote controller 60 then determines whether a control signal has been received 88 by reading the signal feed from the receiver 58. If a control signal has been received, the remote controller 60 signals the stimulus generation circuit 62 to generate a stimulus 90. If no control signal has been received, the remote controller 60 continues to read the signal feed from the receiver 58. In the event a stimulus is generated 90 by the stimulus generation circuit 62, the stimulus delivery mechanism 64 then applies the stimulus 92 to the animal.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A presence detector mat for detecting and monitoring the presence of an animal within a defined area, said presence detector mat comprising:
a variable parallel-plate capacitor comprising first and second conductive planar members;
an elastomeric spacing system disposed between said first and said second conductive planar members;
a planar insulator coupled to said first conductive member;
an electrical power source in electrical communication with said first and second conductive surfaces, said electrical power source configured to provide an electrical charge differential to said first and second conductive surfaces; and,
a sensing mechanism comprising a controller responsive to variation in the capacitance of said variable parallel-plate capacitor;
whereby detection by said controller provides an indication of the presence of an animal within the confines of the detector mat.

2. The presence detector mat of claim 1, said sensing mechanism further comprising a transmitter in electrical communication with said controller, whereby variation in the capacitance of said variable parallel-plate capacitor causes said controller to provide a signal to said transmitter, said transmitter being configured to transmit a signal responsive to the signal provided by said controller.

3. The presence detector mat of claim 1 further comprising a dielectric surface disposed between said first and second conductive surfaces.

4. The presence detector mat of claim 1, wherein said first conductive surface is carried by said planar insulator, said planar insulator serving to insulate said first conductive surface from electrical conductivity with the surrounding environment.

5. The presence detector mat of claim 1, said elastomeric spacing system comprising a plurality of spring members disposed between said first and second conductive surfaces.

6. The presence detector mat of claim 1, said elastomeric spacing system comprising a layer of elastomeric foam disposed between said first and second conductive surfaces.

7. The presence detector mat of claim 1, said first and second conductive surfaces being arranged in a substantially parallel and overlapping configuration.

8. The presence detector mat of claim 1 further comprising a dielectric surface disposed between said first and second conductive surfaces, wherein said first conductive surface is carried by said planar insulator, said planar insulator serving to insulate said first conductive surface from electrical conductivity with the surrounding environment.

9. The presence detector of claim 1 further comprising:
a dielectric surface disposed between said first and second conductive surfaces;
said elastomeric spacing system comprising a plurality of spring members disposed between said first and second conductive surfaces;
wherein said first conductive surface is carried by said planar insulator, said planar insulator serving to insulate said first conductive surface from electrical conductivity with the surrounding environment.

10. The presence detector of claim 1 further comprising:
a dielectric surface disposed between said first and second conductive surfaces;
said elastomeric spacing system comprising a layer of elastomeric foam disposed between said first and second conductive surfaces;
wherein said first conductive surface is carried by said planar insulator, said planar insulator serving to insulate said first conductive surface from electrical conductivity with the surrounding environment.

11. The presence detector of claim 1 further comprising:
a dielectric surface disposed between said first and second conductive surfaces;
said elastomeric spacing system comprising a layer of elastomeric foam disposed between said first and second conductive surfaces;
wherein said first conductive surface is carried by said planar insulator, said planar insulator serving to insulate said first conductive surface from electrical conductivity with the surrounding environment, and wherein said first and second conductive surfaces are arranged in a substantially parallel and overlapping configuration.
